(19) United States
(12) Patent Application Publication
(10) Pub. No.: US 2026/0301727 A1
(43) Pub. Date: Oct. 1, 2026

(54) ACOUSTIC DAMPENER STAND

(71) Applicant: GIK ACOUSTICS EUROPE LTD., Bradford, West Yorkshire (GB)

(72) Inventors: David Paul Shevyn, Haworth, West Yorkshire (GB); Glenn Kuras, Atlanta, GA (US)

(21) Appl. No.: 19/146,461

(22) PCT Filed: Oct. 16, 2023
(86) PCT No.: PCT/US2023/035187

§ 371 Date: Jul. 8, 2025

Related U.S. Application Data
(60) Provisional application No. 63/416,862, filed on Oct. 17, 2022.

(51) Int. Cl. G10K 11/162

(52) U.S. Cl. CPC G10K 11/162

(57) ABSTRACT

An acoustic dampener stand includes a first insulation material defining a first density; a second insulation material defining a second density different from the first density; and a stand frame supporting the first and second insulation materials.

### TECHNICAL FIELD

This disclosure relates to sound control. More specifically, this disclosure relates to an acoustic dampener stand for improving sound quality in a room or surrounding area.

### BACKGROUND

Acoustic dampening devices are configured to dampen different frequencies of sound within an area to improve the overall sound quality in the area, such as by reducing echo/reverberation, ambient noise, and/or low-end frequencies (e.g., a bass trap). Acoustic dampening devices are often provided in the form of acoustic panels that must be installed on the surrounding walls and/or ceiling.

### SUMMARY

It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts of the disclosure as an introduction to the following complete and extensive detailed description.

Disclosed is an acoustic dampener stand comprising a first insulation material defining a first density; a second insulation material surrounding the first insulation material and defining a second density different from the first density; and a stand frame supporting the first and second insulation materials.

Also disclosed is an acoustic dampener stand comprising a stand frame; a first insulation material supported by the stand frame and defining an interior insulation cavity; and a second insulation material disposed within the interior insulation cavity.

An acoustic dampener stand is disclosed comprising a first insulation material defining a first density; a second insulation material defining a second density different from the first density; and a stand frame supporting the first and second insulation materials.

Additionally, disclosed is a method of assembling an acoustic dampener stand, the method comprising providing a stand frame, the stand frame comprising a first support panel, a second support panel, and a support rod extending between the first support panel and the second support panel; arranging a first insulation material between the first support panel and the second support panel, the first insulation material defining a first density; and substantially surrounding the first insulation material with a second insulation material, the second insulation material defining a second density that is different from the first density.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures may be designated by matching reference characters for the sake of consistency and clarity.

FIG. 1 is a perspective view of an acoustic dampener stand, in accordance with one aspect of the present disclosure.

FIG. 2 is a top view of a support frame of the acoustic dampener stand of FIG. 1 in a disassembled configuration.

FIG. 3 illustrates a first step in assembling the acoustic dampener stand of FIG. 1.

FIG. 4 illustrates a second step in assembling the acoustic dampener stand of FIG. 1.

FIG. 5 illustrates a third step in assembling the acoustic dampener stand of FIG. 1.

FIG. 6 illustrates a fourth step in assembling the acoustic dampener stand of FIG. 1.

FIG. 7 illustrates a fifth step in assembling the acoustic dampener stand of FIG. 1.

FIG. 8 illustrates a detailed top perspective view of the acoustic dampener stand in accordance with another aspect of the present disclosure.

FIG. 9 illustrates a stack of two of the acoustic dampener stands of FIG. 8.

### DETAILED DESCRIPTION

The present disclosure can be understood more readily by reference to the following detailed description, examples, drawings, and claims, and the previous and following description. However, before the present devices, systems, and/or methods are disclosed and described, it is to be understood that this disclosure is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description is provided as an enabling teaching of the present devices, systems, and/or methods in its best, currently known aspect. To this end, those skilled in the relevant art will recognize and appreciate that many changes can be made to the various aspects of the present devices, systems, and/or methods described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure.

Thus, the following description is provided as illustrative of the principles of the present disclosure and not in limitation thereof.

As used throughout, the singular forms “a,” “an” and “the” include plural referents unless the context clearly dictates otherwise. Thus, for example, reference to “an element” can include two or more such elements unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutations of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific aspect or combination of aspects of the disclosed methods.

Disclosed is an acoustic dampener stand and associated methods, systems, devices, and various apparatus. Example aspects of the acoustic dampener stand can comprise a stand frame, a first insulation material, and a second insulation material. It would be understood by one of skill in the art that the acoustic dampener stand is described in but a few exemplary embodiments among many. No particular terminology or description should be considered limiting on the disclosure or the scope of any claims issuing therefrom.

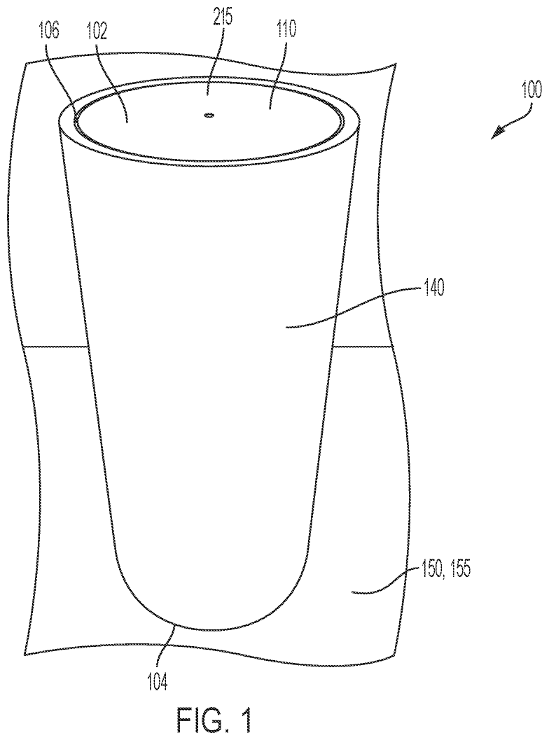

FIG. 1 is a perspective view of an acoustic dampener stand 100, in accordance with one aspect of the present disclosure. One or more of the acoustic dampener stands 100 can be disposed within a room 905 (shown in FIG. 9), or other surrounding area, to dampen desired frequencies of sound within the room 905. Dampening certain frequencies can improve the sound quality in the room 905 by reducing echo/reverberation, ambient noise, “boomy” sound caused by low-end frequencies, etc. In some aspects, one or more of the acoustic dampener stands 100 can be stacked on top of one another to form an acoustic dampener tower 900 (shown in FIG. 9). In some aspects, the acoustic dampener stand 100 can serve as a speaker stand and can support a speaker thereon. For example, in some aspects, the acoustic dampener stand 100 can be configured to support up to about 200 lbs.

The acoustic dampener stand 100 can define a first stand end 102 and a second stand end 104 opposite the first stand end 102. In the orientation shown, the first stand end 102 can be an upper stand end 102, and the second stand end 104 can be a lower stand end 104. The acoustic dampener stand 100 can be configured to stand vertically upright as shown with the lower stand end 104 resting on a support surface 150, such as a floor 155 or table top. In other aspects, the acoustic dampener stand 100 can be configured to lay on a side thereof.

Example aspects of the acoustic dampener stand 100 can define a substantially cylindrical shape extending from the upper stand end 102 to the lower stand end 104. In other aspects, however, the acoustic dampener stand 100 can define any other suitable shape, including, for example and without limitation, a triangular or rectangular prism, a triangular or rectangular pyramid, or the like.

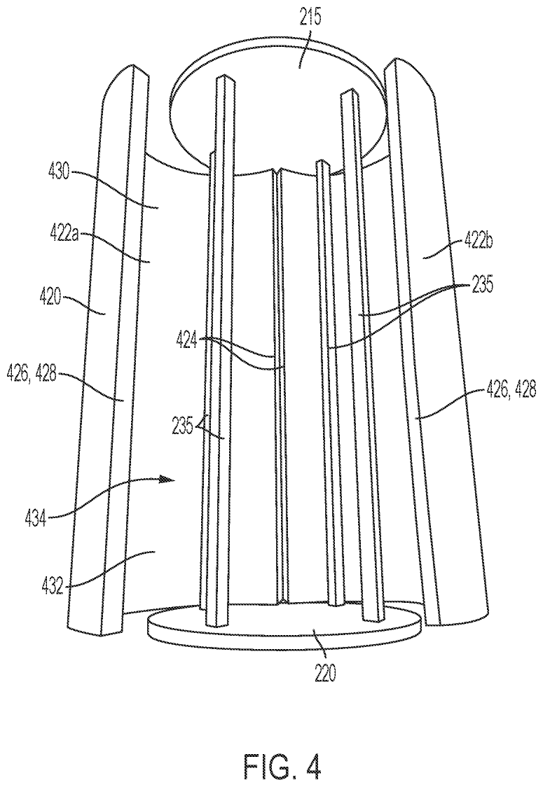

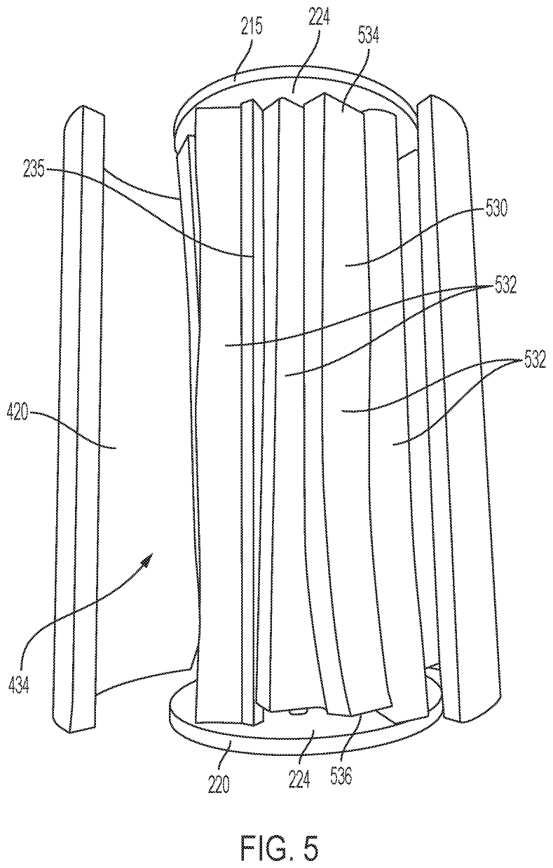

The acoustic dampener stand 100 can comprise a first insulation material 420 (shown in FIG. 4), a second insulation material 530 (shown in FIG. 5), and a stand frame 110 for supporting the first insulation material 420 and the second insulation material 530. The first and second insulation materials 420,530 are described in further detail below. Example aspects of the stand frame 110 can comprise a wood material, as shown. In other aspects, the stand frame 110 can comprise any other suitable material, including but not limited to, metals, plastics, composites, and the like. In some aspects, an outer cover 140 can be provided for covering and protecting the first and second insulation materials 420,530. The outer cover 140 can cover may also fully or partially cover the stand frame 110. In the present aspect, the stand frame 110 can be partially exposed. Specifically, portions of the stand frame 110 can be exposed at the upper stand end 102 and the lower stand end 104 of the acoustic dampener stand 100. In some aspects, the outer cover 140 may be decorative or aesthetically pleasing.

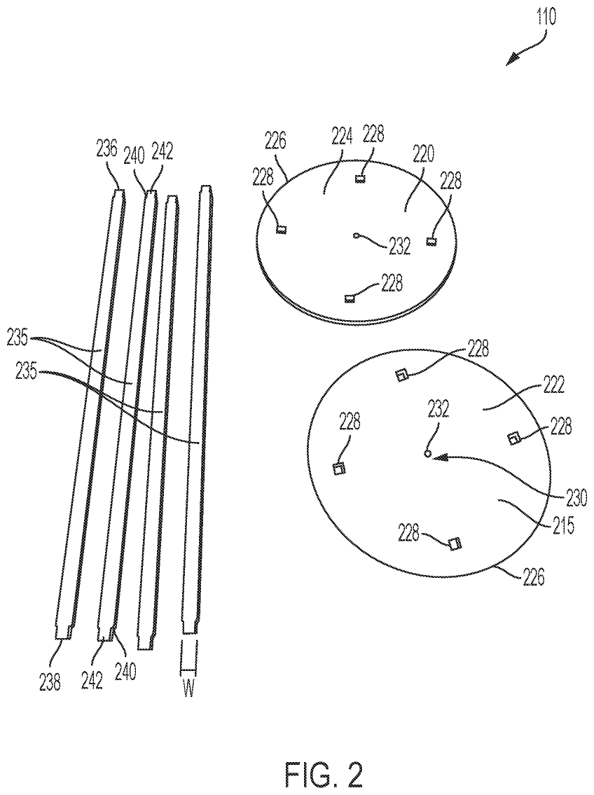

A first support panel 215 of the stand frame 110 can be arranged at the upper stand end 102, and a second support panel 220 (shown in FIG. 2) of the stand frame 110 can be arranged at the lower stand end 104. In some aspects, a sealing ring 106 can encircle each of the first support panel 215 and the second support panel 220. The sealing ring 106 can comprise a rubber material in example aspects. In other aspects, the sealing ring 106 can define any other suitable material. According to example aspects, the sealing rings 106 can provide a seal between the first and/or second insulation materials 420,530 and the stand frame 110.

FIG. 2 illustrates the stand frame 110 in a disassembled configuration. The stand frame 110 can comprise the first support panel 215, the second support panel 220, and one or more support rods 235. The first support panel 215 can be an upper support panel 215, and the second support panel 220 can be a lower support panel 220 in the present aspect. Each of the upper and lower support panels 215,220 can be formed as a substantially planar disc defining an outer panel surface 222 and an inner panel surface 224 opposite the outer panel surface 222. Each of the upper and lower support panels 215,220 can further define an outer panel edge 226. In example aspects, the upper support panel 215 can define a width and/or diameter than is larger than a width and/or diameter of the lower support panel 220, as described in further detail below.

Each of the upper and lower support panels 215,220 can further define one or more rod openings 228 extending therethrough from the inner panel surface 224 to the outer panel surface 222. For example, each of the upper and lower support panels 215,220 can define four of the rod openings 228 formed therethrough. Each of the rod openings 228 can be substantially rectangular (e.g., square-shaped) in the present aspect. Furthermore, the four rod openings 228 can be arranged in a square pattern, and each of the rod openings 228 can be spaced equidistant from a center 230 of the corresponding upper or lower support panel 215,220. Some aspects of the upper support panel 215 and/or lower support panel 220 can define a center hole 232 formed through the center 230 thereof. The center hole 232 can extend fully or partially through the upper and/or lower support panels 215,220. However, other aspects of the upper support panel 215 and/or lower support panel 220 do not define the center hole 232.

In other aspects, the upper and lower support panels 215,220 can define more or fewer of the rod openings 228, and the rod openings 228 can be arranged in any other suitable pattern. In other aspects, the rod openings 228 can define any other suitable shape, such as circular or triangular for example and without limitation. In other aspects, the rod openings 228 may extend only partially through the corresponding upper and lower support panels 215,220. For example, each of the rod openings 228 may be formed as a blind hole extending into the corresponding inner panel surface 224. In other aspects, the upper support panel 215 and/or lower support panel 220 may not define the center hole 232. In other aspects, the upper support panel 215 and/or the lower support panel 220 can be about equal in diameter/size, or the lower support panel 220 can define a larger diameter/size than the upper support panel 215.

Each of the support rods 235 can be substantially elongate and can define a first rod end 236 and a second rod end 238 opposite the first rod end 236. The first rod end 236 of each support rod 235 can be configured to engage a corresponding one of the rod openings 228 in the upper support panel 215, and the second rod end 238 of each support rod 235 can be configured to engage a corresponding one of the rod openings 228 in the lower support panel 220. Thus, the stand frame 110 can comprise four of the support rods 235 in the present aspect. In other aspects, the number of support rods 235 can differ based on the number of rod openings 228 provided. The first and second rod ends 236,238 of each support rod 235 can be shaped to substantially match the shape of the rod openings 228. For example, in the present aspect, the first and second rod ends 236,238 can define a square cross-sectional shape to substantially match the square rod openings 228. Furthermore, the first and second rod ends 236,238 can be sized to substantially match or be just slightly larger than the size of the rod openings 228, such that the first and second rod ends 236,238 can be retained within the corresponding rod openings 228 by friction fit. In other aspects, the support rods 235 can be coupled to the upper and lower support panels 215,220 by any other suitable fastener(s) or fastening technique(s), such as adhesives or screws, for example and without limitation.

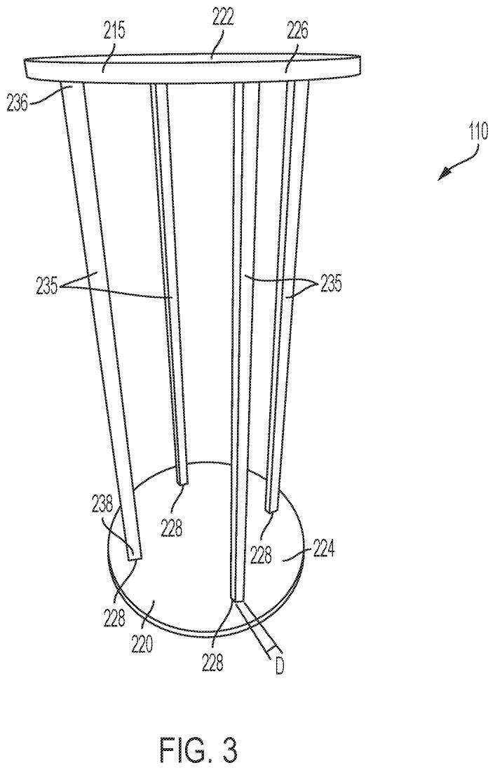

Moreover, in some aspects, a width W and/or a depth D (shown in FIG. 3) of the support rods 235 can be reduced at the first rod end 236 and the second rod end 238 to define a rod shoulder 240 proximate to each of the first and second rod ends 236,238. A corresponding panel engagement portion 242 can be defined between each rod shoulder 240 and the corresponding first or second rod end 236,238 of the support rod 235. Each panel engagement portion 242 can engage one of the rod openings 228 of the corresponding upper or lower support panel 215,220, and the adjacent rod shoulder 240 can abut the inner panel surface 224 of the corresponding upper or lower support panel 215,220. In some aspects, the rod shoulders and the panel engagement portions 242 can be machined into the support rods 235, such as by CNC machining, for example and without limitation. Other aspects of the support rods 235 may not define the rod shoulders 240. FIG. 3 illustrates the stand frame 110 in an assembled configuration, wherein each of the support rods 235 can extend between the upper support panel 215 and the lower support panel 220. In other aspects, the stand frame 110 may not comprise the upper support panel 215 and/or the lower support panel 220, or a sizable opening can be defined through the upper support panel 215 and/or the lower support panel 220, such that the acoustic dampener stand 100 (shown in FIG. 1) can be substantially open at the upper stand end 102 and/or the lower stand end 104.

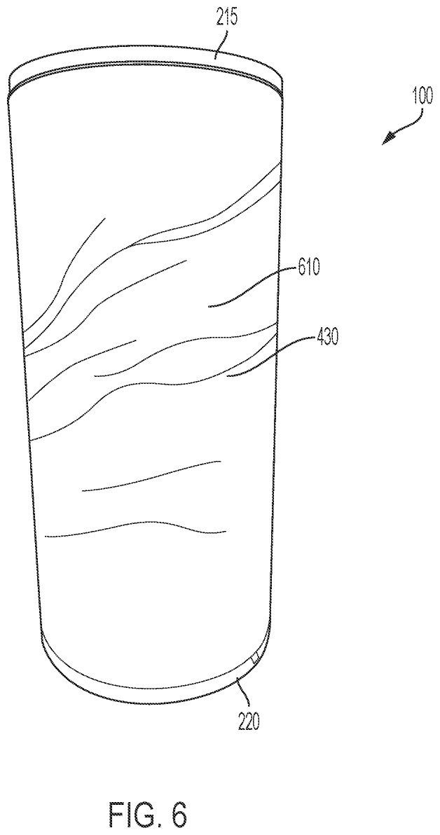

FIG. 4 illustrates the first insulation material 420 partially assembled with the support frame. In the present aspect, the first insulation material 420 can comprise two pieces 422a, b of material. In example aspects, each of the two pieces 422a, b can be cut from a flexible, substantially planar insulation blank. In other aspects, however, the first insulation material 420 can comprise a singular piece of material or additional pieces of material. Each of the two pieces 422a, b of the first insulation material 420 can define a first insulation end 424 and a second insulation end 426 opposite the first insulation end 424. In some aspects, the first insulation ends 424 of the two pieces 422a, b can be coupled together by any suitable fastener(s) or fastening technique(s), including but not limited to, adhesives such as tape or glue, such that the two pieces 422a, b can together define a continuous outer insulation layer 430 of the first insulation material 420. In the present aspect, the first insulation ends 424 are not affixed together but can be held in confrontation with one another by the outer cover 140 (shown in FIG. 1) and/or a protective sheet 610 (shown in FIG. 6).

The outer insulation layer 430 of the first insulation material 420 can be configured to wrap around the support rods 235 and nest between the upper support panel 215 and the lower support panel 220. An inner insulation surface 432 of the outer insulation layer 430 can define an interior insulation cavity 434 within which the support rods 235 and the second insulation material 530 (shown in FIG. 5) can be disposed. The second insulation ends 426 of the two pieces 422a, b can be free ends 428 that can be folded towards one another and coupled together later in the assembly process to form the outer insulation layer 430 into a cylindrical shape that can surround the interior insulation cavity 434 and the second insulation material 530 therein.

Example aspects of the first insulation material 420 can comprise a foam insulation material. The foam insulation material of the first insulation material 420 can be a rockwool insulation material in some aspects, for example and without limitation. In other aspects, the first insulation material 420 can comprise any other suitable insulation material, including foam and non-foam materials. The first insulation material 420 can define a first density. In the present aspect, the first density of the first insulation material 420 can be about 3 lbs/sq. ft. Other aspects of the first insulation material 420 can comprise any other suitable type of insulation material and/or can define a higher or lower first density as desired for specific acoustic properties.

Example aspects of the second insulation material 530 can also comprise a foam insulation material. The foam insulation material of the second insulation material 530 can be a rockwool insulation material in some aspects, for example and without limitation. In other aspects, the first insulation material 530 can comprise any other suitable insulation material, including foam and non-foam materials. In example aspects, the second insulation material 530 can define a second density that can be different than the first density. For example, in the present aspect, the second density of the second insulation material 530 can be about 6 lbs/sq. ft. Other aspects of the second insulation material 530 can comprise any other suitable type of insulation material and/or can define a higher or lower second density as desired for specific acoustic properties. Insulation materials having a lower density can be better for absorbing mid-to high-frequency sounds, while insulation materials having a higher density can be better for absorbing low-frequency sounds. Providing the acoustic dampener stand 100 with both the first insulation material 420 having the lower first density and the second insulation material 530 having the higher second density can have the benefit of absorbing low-, mid-, and high-frequency sounds. In other aspects, the densities of the first and second insulation materials 420,530 can be equal or about equal, again as desired for specific acoustic properties.

FIG. 5 illustrates the second insulation material 530 disposed within the interior insulation cavity 434. In the present aspect, the second insulation material 530 can comprise a plurality of elongate strips 532 of material. The elongate strips 532 can be substantially rectangular, as shown, or can define any other suitable shape. In example aspects, each of the elongate strips 532 can be cut from a flexible, substantially planar insulation blank. The elongate strips 532 of the second insulation material 530 can be disposed within the interior insulation cavity 434 defined by the first insulation material 420. Each of the elongate strips 532 can define a first strip end 534 and a second strip end 536. The first strip end 534 of each elongate strip 532 can confront (and in some instances can abut) the inner panel surface 224 of the upper support panel 215, and the second strip end 536 of each elongate strip 532 can confront (an in some instances can abut) the inner panel surface 224 of the lower support panel 220. A suitable number of elongate strips 532 can be provided to substantially fill the entire interior insulation cavity 434. However, the elongate strips 532 can be loosely packed within the interior insulation cavity 434 so as not to compress the elongate strips 532, as compressing the elongate strips 532 may affect the density of the second insulation material 530. In some aspects, the support rods 235 can aid in retaining some or all of the elongate strips 532 within the interior insulation cavity 434.

In other aspects, the second insulation material 530 can comprise more or fewer strips 532 of material. Additionally, in other aspects, the elongate strips 532 may only partially fill the interior insulation cavity 434. Moreover, in other aspects, the second insulation material 530 can take any suitable form other than the strips 532. For example and without limitation, the second insulation material 530 can be formed as a singular block of insulation material extending between the upper and lower support panels 215,220, as a plurality of insulation discs stacked vertically between the upper and lower support panels 215,220, or the like.

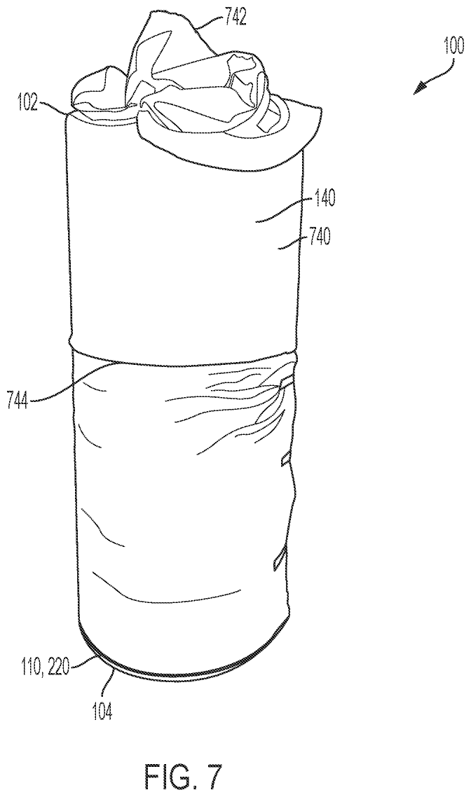

FIG. 6 illustrates the outer insulation layer 430 comprising the first insulation material 420 (shown in FIG. 4) fully wrapped around acoustic dampener stand 100. The second insulation ends 426 (shown in FIG. 4) of the outer insulation layer 430 can be folded towards one another to form the outer insulation layer 430 into a cylindrical shape that surrounds the interior insulation cavity 434 (shown in FIG. 4) and encloses the second insulation material 530 (shown in FIG. 5) and the support rods 235 (shown in FIG. 2) therein. In some aspects, the outer insulation layer 430 can comprise a protective sheet 610 wrapped around the first insulation material 420. The protective sheet 610 can be configured to protect the first insulation material 420 and the second insulation material 530 from dust, dirt, moisture, and the like. The protective sheet 610 can be secured around the first insulation material 420 with any suitable fastener(s) or fastening technique(s), including but not limited to, adhesives such as glue or tape (shown in FIG. 7). In some aspects, the sheet 610 can facilitate sliding the outer cover 140 (shown in FIG. 1) onto the acoustic dampener stand 100. Other aspects of the acoustic dampener stand 100 do not comprise the protective sheet 610.

Referring to FIG. 7, in some aspects, the acoustic dampener stand 100 can be provided with the outer cover 140 for further covering and protecting the first and second insulation materials 420,530 (shown in FIGS. 4 and 5, respectively). In the present aspect, the outer cover 140 can be formed as a substantially cylindrical sleeve 740. The cylindrical sleeve 740 is shown being slipped over the acoustic dampener stand 100 in the present view. As shown, the cylindrical sleeve 740 can define a first sleeve end 742 and a second sleeve end 744 opposite the first sleeve end 742. When the cylindrical sleeve 740 is slipped fully over the acoustic dampener stand 100 (as shown in FIG. 1), the first sleeve end 742 can be disposed at upper stand end 102, and the second sleeve end 744 can be disposed at the lower stand end 104. In example aspects, the first sleeve end 742 can be tightened over (such as with elastic or a drawstring) or affixed to the upper support panel 215 (shown in FIG. 2) of the stand frame 110, and the second sleeve end 744 can be tightened over or affixed to the lower support panel 220 of the stand frame 110 to retain the outer cover 140 on the acoustic dampener stand 100, such as with adhesives, staples, hook-and-loop fasteners, or other fasteners. In example aspects, the upper support panel 215 and/or the lower support panel 220 can be left partially uncovered by the outer cover 140, while in other aspects, the upper support panel 215 and/or the lower support panel 220 can be fully covered by the outer cover 140.

In some aspects, the first insulation ends 424 (shown in FIG. 4) of the first insulation material 420 (shown in FIG. 4) may not be affixed to one another, and the second insulation ends 426 (shown in FIG. 4) of the first insulation material 420 may not be affixed to one another. In the present aspect, the first insulation ends 424 can be held in confrontation with one another and the second insulation ends 426 can be held in confrontation with one another by the cylindrical sleeve 740 surrounding the first insulation material 420.

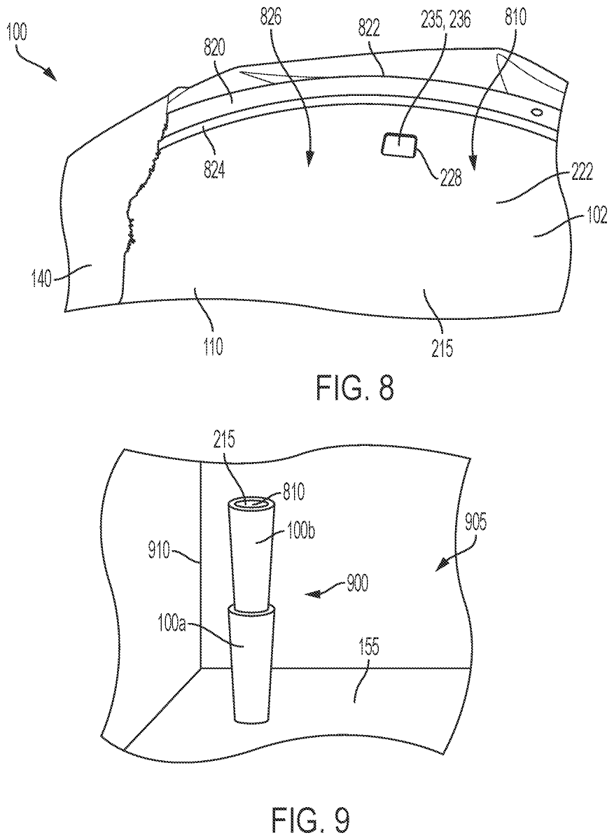

FIG. 8 illustrates a close-up view of the upper stand end 102 of the acoustic dampener stand 100. In some aspects, the acoustic dampener stand 100 can define a stacking recess 810 at the upper stand end 102. As previously described, the upper support panel 215 of the stand frame 110 can be disposed at the upper stand end 102. The first rod end 236 of each support rod 235 can engage a corresponding one of the rod openings 228 in the upper support panel 215, as shown. The second rod end 238 (shown in FIG. 2) of each support rod 235 can engage the lower support panel 220 (shown in FIG. 2) in substantially the same manner. In the present aspect, the first rod end 236 of each support rod 235 can be substantially flush with the outer panel surface 222 of the upper support panel 215. In other aspects, the first rod ends 236 can be recessed within the corresponding rod openings 228.

Furthermore, as described with respect to FIG. 2, in some aspects, the diameter of the upper support panel 215 can greater than the diameter of the lower support panel 220 (shown in FIG. 2). As shown, a positioning ring 820 can be mounted on the outer panel surface 222 of the upper support panel 215. In example aspects, an outer diameter of the positioning ring 820 can be about equal to the diameter of the upper support panel 215, such that an outer ring edge 822 of the positioning ring 820 can be aligned and substantially flush with the outer panel edge 226 (shown in FIG. 2) of the upper support panel 215. An inner ring edge 824 of the of the positioning ring 820 can define a ring opening 826 through a center of the positioning ring 820.

The inner ring edge 824 of the positioning ring 820 and the outer panel surface 222 of the upper support panel 215 can together define the stacking recess 810. According to example aspects, a diameter of the ring opening 826 can be about equal to or greater than the diameter of the lower support panel 220, such that the lower support panel 220 can be sized to fit within the stacking recess 810. The lower support panel 220 of a second acoustic dampener stand 100b (shown in FIG. 9) can be received within the stacking recess 810 of a first acoustic dampener stand 100a (shown in FIG. 9) to prevent lateral sliding of the lower support panel 220 and to allow for stable stacking of the second acoustic dampener stand 100b on the first acoustic dampener stand 100a. In other aspects, the stacking recess 810 can be formed in the lower support panel 220, such that the upper support panel 215 of the first acoustic dampener stand 100a can engage the stacking recess 810 of the lower support panel 220 of the second acoustic dampener stand 100b when stacking the second acoustic dampener stand 100b on the first acoustic dampener stand 100a. In other aspects, the stacking recess 810 can be alternatively formed, such as by machining the stacking recess 810 into the outer panel surface 222 of the upper support panel 215, for example and without limitation.

FIG. 9 illustrates the first acoustic dampener stand 100a positioned on the floor 155 in a corner 910 of the room 905. As shown, the second acoustic dampener stand 100b can be stacked on top of the first acoustic dampener stand 100a as described above to form the acoustic dampener tower 900. Other aspects of the acoustic dampener stands 100 may not comprise the stacking recess 810, and the second acoustic dampener stand 100b can simply rest atop the first acoustic dampener stand 100a.

In one exemplary aspect, an acoustic dampener stand can comprise a first insulation material defining a first density, a second insulation defining a second density different from the first density, and a stand frame supporting the first and second insulation materials.

In a further exemplary aspect, the first insulation material can substantially surround the second insulation material, and the first insulation material can define an interior insulation cavity within which the second insulation material can be disposed. In a further exemplary aspect, the first density of the first insulation material can be less than the second density of the second insulation material. In a further exemplary aspect, each of the first insulation material and the second insulation material can comprise a foam material. In a further exemplary aspect, the second insulation material can comprise a plurality of strips of the second insulation material, and the first insulation material can substantially surround the plurality of strips of the second insulation material. In a further exemplary aspect, the stand frame can comprise a first support panel at a first stand end of the acoustic dampener stand, a second support panel at a second stand end of the acoustic dampener stand opposite the first stand end, and a support rod extending between the first support panel and the second support panel. In a further exemplary aspect, each of the first insulation material and the second insulation material can extend between the first support panel and the second support panel. In a further exemplary aspect, the first support panel can define a first rod opening, the second support panel can define a second rod opening, the support rod can define a first rod end engaged with the first rod opening, and the support rod further can define a second rod end opposite the first rod end and engaged with the second rod opening. In a further exemplary aspect, the support rod can define a first panel engagement portion at the first rod end and a first rod shoulder proximate to the first rod end, the first panel engagement portion can engage the first rod opening and the first rod shoulder can abut a first inner panel surface of the first support panel, the support rod further can define a second panel engagement portion at the second rod end and a second rod shoulder proximate to the second rod end, and the second panel engagement portion can engage the second rod opening and the second rod shoulder can abut a second inner panel surface of the second support panel. In a further exemplary aspect, the first support panel can be an upper support panel, the second support panel can be a lower support panel configured to rest on a support surface, and the support rod can extend vertically between the upper support panel and the lower support panel. In a further exemplary aspect, the upper support panel can define a stacking recess configured to receive the lower support panel of a second acoustic dampener stand to vertically stack the second acoustic dampener stand on the acoustic dampener stand. In a further exemplary aspect, a width of the upper support panel can be greater than a width of the lower support panel. In a further exemplary aspect, the acoustic dampener stand further can comprise an outer cover surrounding and protecting the first insulation material and the second insulation material.

In another exemplary aspect, a method of assembling an acoustic dampener stand can comprise providing a stand frame. The stand frame can comprise a first support panel, a second support panel, and a support rod extending between the first support panel and the second support panel. The method can further comprise arranging a first insulation material between the first support panel and the second support panel. The first insulation material can define a first density. The method can further comprise substantially surrounding the first insulation material with a second insulation material. The second insulation material can define a second density that is different from the first density.

In a further exemplary aspect, the first density of the first insulation material can be greater than the second density of the second insulation material. In a further exemplary aspect, providing the stand frame can comprise engaging a first rod end of the support rod with a first rod opening of the first support panel and engaging a second rod end of the support rod with a second rod opening of the second support panel. In a further exemplary aspect, engaging the first rod end of the support rod with the first rod opening of the first support panel further can comprise abutting a first rod shoulder of the support rod against a first inner panel surface of the first support panel, and engaging the second rod end of the support rod with the second rod opening of the second support panel further can comprise abutting a second rod shoulder of the support rod against a second inner panel surface of the second support panel. In a further exemplary aspect, arranging the first insulation material between the first support panel and the second support panel can comprise arranging a plurality of strips of the first insulation material within an interior insulation cavity of the acoustic dampener stand. In a further exemplary aspect, substantially surrounding the first insulation material with the second insulation material can comprise wrapping one or more pieces of the second insulation material around the first insulation material to define the interior insulation cavity. In a further exemplary aspect, the method further can comprise disposing an outer cover over the first insulation material and the second insulation material to cover and protect the first and second insulation materials.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. An acoustic dampener stand comprising:
a first insulation material defining a first density;
a second insulation defining a second density different from the first density; and
a stand frame supporting the first and second insulation materials.

2. The acoustic dampener stand of claim 1, wherein the first insulation material substantially surrounds the second insulation material, and wherein the first insulation material defines an interior insulation cavity within which the second insulation material is disposed.

3. The acoustic dampener stand of claim 2, wherein the first density of the first insulation material is less than the second density of the second insulation material.

4. The acoustic dampener stand of claim 3, wherein each of the first insulation material and the second insulation material comprise a foam material.

5. The acoustic dampener stand of claim 2, wherein the second insulation material comprises a plurality of strips of the second insulation material, and wherein the first insulation material substantially surrounds the plurality of strips of the second insulation material.

6. The acoustic dampener stand of claim 1, wherein the stand frame comprises:
a first support panel at a first stand end of the acoustic dampener stand;
a second support panel at a second stand end of the acoustic dampener stand opposite the first stand end; and
a support rod extending between the first support panel and the second support panel.

7. The acoustic dampener stand of claim 6, wherein each of the first insulation material and the second insulation material extend between the first support panel and the second support panel.

8. The acoustic dampener stand of claim 6, wherein:
the first support panel defines a first rod opening;
the second support panel defines a second rod opening;
the support rod defines a first rod end engaged with the first rod opening; and
the support rod further defines a second rod end opposite the first rod end and engaged with the second rod opening.

9. The acoustic dampener stand of claim 8, wherein:
the support rod defines a first panel engagement portion at the first rod end and a first rod shoulder proximate to the first rod end;
the first panel engagement portion engages the first rod opening and the first rod shoulder abuts a first inner panel surface of the first support panel;
the support rod further defines a second panel engagement portion at the second rod end and a second rod shoulder proximate to the second rod end; and
the second panel engagement portion engages the second rod opening and the second rod shoulder abuts a second inner panel surface of the second support panel.

10. The acoustic dampener stand of claim 6, wherein:
the first support panel is an upper support panel;
the second support panel is a lower support panel configured to rest on a support surface; and
the support rod extends vertically between the upper support panel and the lower support panel.

11. The acoustic dampener stand of claim 10, wherein the upper support panel defines a stacking recess configured to receive the lower support panel of a second acoustic dampener stand to vertically stack the second acoustic dampener stand on the acoustic dampener stand.

12. The acoustic dampener stand of claim 11, wherein a width of the upper support panel is greater than a width of the lower support panel.

13. The acoustic dampener stand of claim 1, further comprising an outer cover surrounding and protecting the first insulation material and the second insulation material.

14. A method of assembling an acoustic dampener stand, the method comprising:
providing a stand frame, the stand frame comprising a first support panel, a second support panel, and a support rod extending between the first support panel and the second support panel;
arranging a first insulation material between the first support panel and the second support panel, the first insulation material defining a first density; and
substantially surrounding the first insulation material with a second insulation material, the second insulation material defining a second density that is different from the first density.

15. The method of claim 14, wherein the first density of the first insulation material is greater than the second density of the second insulation material.

16. The method of claim 14, wherein providing the stand frame comprises:
engaging a first rod end of the support rod with a first rod opening of the first support panel; and
engaging a second rod end of the support rod with a second rod opening of the second support panel.

17. The method of claim 16, wherein:
engaging the first rod end of the support rod with the first rod opening of the first support panel further comprises abutting a first rod shoulder of the support rod against a first inner panel surface of the first support panel; and
engaging the second rod end of the support rod with the second rod opening of the second support panel further comprises abutting a second rod shoulder of the support rod against a second inner panel surface of the second support panel.

18. The method of claim 14, wherein arranging the first insulation material between the first support panel and the second support panel comprises arranging a plurality of strips of the first insulation material within an interior insulation cavity of the acoustic dampener stand.

19. The method of claim 18, wherein substantially surrounding the first insulation material with the second insulation material comprises wrapping one or more pieces of the second insulation material around the first insulation material to define the interior insulation cavity.

20. The method of claim 14, further comprising disposing an outer cover over the first insulation material and the second insulation material to cover and protect the first and second insulation materials.
